(19) United States
(12) Patent Application Publication
(10) Pub. No.: US 2017/0347400 A1
(43) Pub. Date: Nov. 30, 2017

(54) TOOL HANDLE HEATER

(71) Applicant: Matthew Roy Krusto, Kelowna (CA)

(72) Inventor: Matthew Roy Krusto, Kelowna (CA)

(21) Appl. No.: 15/167,502

(22) Filed: May 27, 2016

(51) Int. Cl. H05B 3/18; H05B 3/06; H05B 3/00

(52) U.S. Cl. CPC H05B 3/18; H05B 3/0014; H05B 3/06

(57) ABSTRACT

An apparatus for heating the handle of an electric hand tool, the handle having an interior wall defining a cavity therein comprises an electric heating element adapted to be adhered to the interior wall of the handle and an electrical connection adapted to be electrically connected to an electrical supply for the tool. An electric hand tool comprises a tool body having a handle therein, the handle having an interior wall defining a cavity therein and an electrical supply input cord operable to be connected to a power source. The electric hand tool further comprises an electric heating element adapted to be adhered to the interior wall of the handle and an electrical connection adapted to be electrically connected to an electrical supply for the tool.

### BACKGROUND OF THE INVENTION

### 1. Field of Invention

The present invention relates to heaters in general and in particular to a method and apparatus for heating a tool handle.

### 2. Description of Related Art

In the field of construction, many hand tools are required to be utilized at locations experiencing cold temperatures. Such hand tools commonly have a handle which may be grasped or otherwise held by a user and a tool or working and for performing the required tools of function. As a user is required to grab the handle so as to operate the tool, the hands of an operator may be exposed to the cold temperatures. Such cold temperatures may reduce the operator's ability to properly operate the tool, or may also reduce the length of time that the operator is able to work with the tool.

One common solution to operating hands tools in cold environments has been to provide a tent or other heated structure around the work location. Such solutions are expensive and time-consuming to set up and also limit the flexibility of the hand tools to be utilized inside such locations. Another solution to prevent cold hands of an operator has been for the operator to wear insulated gloves or mittens so as to keep their hands warm during the operation. It will be appreciated that such gloves may limit the mobility and dexterity of the users fingers and therefore may compromise the accuracy to operate the hand tool.

Previous attempts have been made to heat handles of tools or other objects so as to reduce discomfort on the user. Such attempts however have commonly applied a heated grip around the handle which includes such heaters. Disadvantageously these extra grips either increases the size of the overall handle from the original dimensions thereby making the handle more difficult to hold or require replacement of the original grip with the heated grips. Examples of such solutions may be found in U.S. Pat. No. 5,735,037 to Ogata and U.S. Pat. No. 7,802,812 to Ohishi et al. as well as U.S. Patent Application Publication No. 2011/0232038 to Miller.

### SUMMARY OF THE INVENTION

According to a first embodiment of the present invention there is disclosed an apparatus for heating the handle of an electric hand tool, the handle having an interior wall defining a cavity therein. The apparatus comprises an electric heating element adapted to be adhered to the interior wall of the handle and an electrical connection adapted to be electrically connected to an electrical supply for the tool.

Each electric heating element may be sized to extend around a majority of the interior wall of the handle. The electric heating element may comprise two electric heating elements. Each of the two electric heating elements may be located inside one half of the handle of the tool. The electric heating element may comprise a flexible heating element.

The electrical connection may be connected to a switch of the electric hand tool. The electrical connection may include a temperature controller to interrupt the electrical connection above a predetermined temperature.

According to a further embodiment of the present invention there is disclosed an electric hand tool comprising a tool body having a handle therein, the handle having an interior wall defining a cavity therein and an electrical supply input cord operable to be connected to a power source. The electric hand tool further comprises an electric heating element adapted to be adhered to the interior wall of the handle and an electrical connection adapted to be electrically connected to an electrical supply for the tool.

The interior wall of the handle may include a recessed portion sized to receive the electric heating element therein. Each electric heating element may be sized to extend around a majority of the interior wall of the handle. The electric heating element may comprise two electric heating elements. Each of the two electric heating elements may be located inside one half of the handle of the tool.

The electric heating element may comprise a flexible heating element. The electrical connection may be connected to a switch of the electric hand tool. The electrical connection may include a temperature controller to interrupt the electrical connection above a predetermined temperature.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of an electric hand tool.

FIG. 2 is a cross sectional view of the electric hand tool of FIG. 1 as taken along the line 2-2 having an electric heating element therein.

FIG. 3 is an exploded view of the electric hand tool of FIG. 1 at an intermediate step of installing the electric heating element.

FIG. 4 is a cross sectional view of the electric hand tool of FIG. 1 as taken along the line 2-2 having an electric heating element therein according to an alternative embodiment.

FIG. 5 is an illustration of a wiring diagram for the electric hand tool of FIG. 1 having the electric heating element therein.

### DETAILED DESCRIPTION

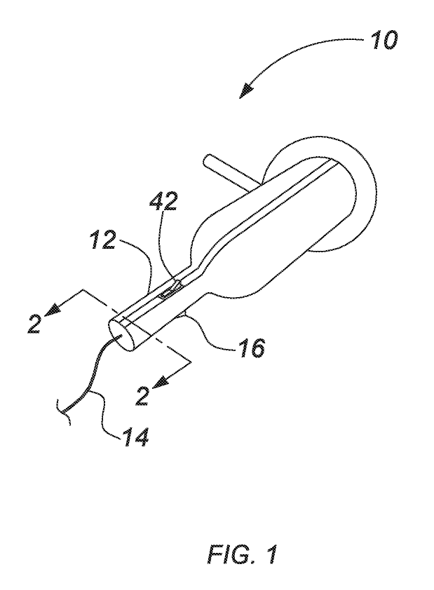

Referring to FIG. 1, an electric hand tool according to a first embodiment of the invention is shown generally at 10. As illustrated in FIG. 1, the electric hand tool 10 may comprise an angle grinder although it will be appreciated that any other electric tool may also be utilized, such as by way of non-limiting example, a drill, saw, impact driver, sander or the like. The electric hand tool 10 includes a handle 12 and a power cord 14. As illustrated, the electric hand tool 10 may also include an on/off switch 16 or a trigger to activate the tool. In operation, the power cord 14 is plugged into a power supply as is commonly known and the user may then press the trigger or otherwise turn the on/off switch on to activate the power tool.

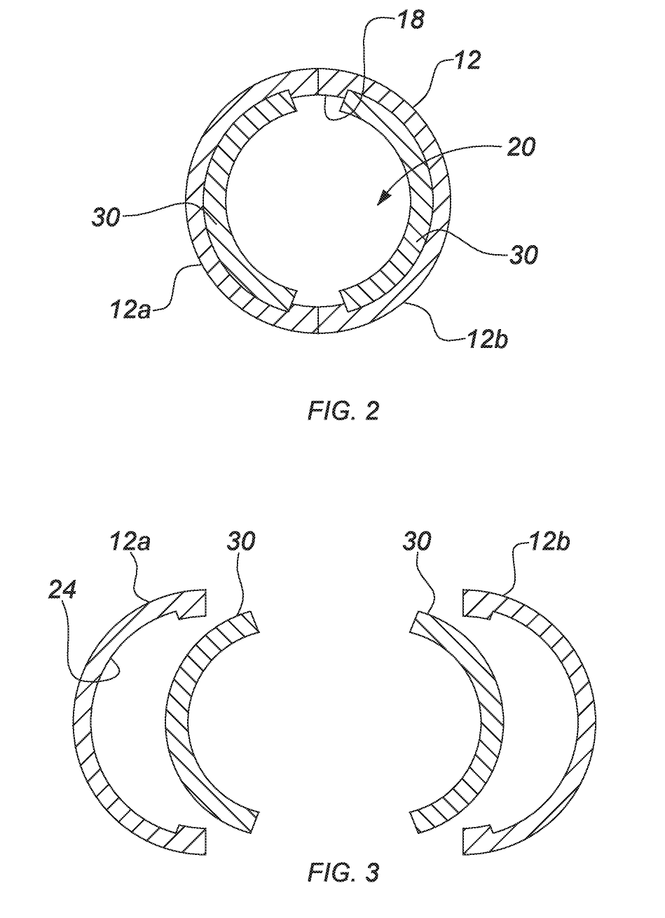

Turning now to FIGS. 2 through 4, a cross section of the handle 12 of the electric hand tool is illustrated. The handle 12 has an inner surface 18 defining a central cavity 20 therein. The inner surface 18 includes an electric heating element 30 disposed on the inner surface 18 to provide heat thereto. As illustrated in FIG. 3, the inner surface 18 may include a recessed portion 24 in which a portion of the handle 12 has been removed so as to provide a mounting location for the electric heating element 30. It will be appreciated that as much material from the handle 12 may be removed as is possible so as to improve heat flow through the handle wall to the user's hand on the outside thereof while still maintaining structural integrity of the handle 12. Optionally, the cavity may thereafter be filled with spray in foam or other insulating material to prevent contact between and electrical supply or control wire and the electric heating element 30.

As illustrated in FIG. 3, the tool 10 may be assembled by separating the first and second halves 12a and 12b from each other and thereafter forming the recessed portion 24 into the inner surface thereof by any known means, such as, by way of non-limiting example, machining, abrading etching or the like. Thereafter the electric heating elements 30 may be secured within the recessed portions 24 and secured therein through any known method, such as, by way of non-limiting example, adhesives, fasteners or the like.

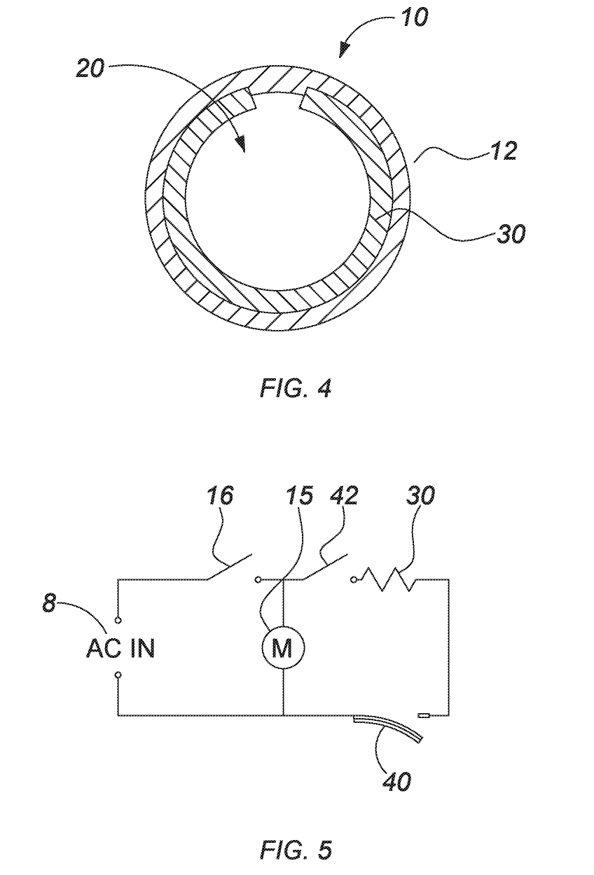

Turning now to FIG. 4, the electric hand tool 10 may optionally be formed of a unitary casing. Although a single electric heating element 30 is illustrated in FIG. 4, and two electric heating elements 30 are illustrated in FIG. 2, it will be appreciated that other quantities of electrical heating elements may be utilized as well. In such applications the electric heating element 30 may be rolled smaller than the cavity and a layer of adhesive applied to the rear thereof such that the electrical heating element may then be inserted into the cavity and allowed to adhere to the inner surface 18 of the handle.

The electric heating element 30 may comprise any suitable resistive heating element operable to be formed to the interior of the handle 12. In particular, it has been found that silicone rubber heaters or polyimide, such as, by way of non-limiting example, manufactured under the trademark Kapton® have been useful although it will be appreciated that any other heater, such as, by way of non-limiting example, polymer thick film heaters and mica heaters may be useful as well.

Turning now to FIG. 5, an electrical circuit diagram is illustrated for use in the providing an electric heating element 30 to the handle 12. As illustrated in FIG. 5, the electric hand tool 10 will commonly include a switch 16 and an electric motor 15 operable to receive electricity from a power supply 8, such as, by way of non-limiting example, through the power cord 14. The electric heating element 30 may be electrically connected to the switch 16 in common with the electric motor 15 so as to be activated at the same time thereas. The electric hand tool 10 may also include a bimetallic strip 40 in series connection with the electric heating element 30 so as to be operable to permit operation of the electric heating element 30 when the interior of the handle 12 is below a predetermined set point, such as, by way of non-limiting example, approximately 120 degrees Fahrenheit although it will be appreciated that other temperatures may be useful as well. The bimetallic strip 40 may be located within the cavity 20 or may optionally be secured to a portion of the electric hand tool casing to measure the temperature thereof. The bimetallic strip 40 may also be secured to or under the electric heating element 30. Bimetallic strip 40 prevents the operation of the electric heating element 30 above the desired temperature to avoid heating the users hand during warm weather or to prevent damage to the electric hand tool due to overheating. Although a bimetallic strip 40 is illustrated and set out above, it will be appreciated that other temperature control switches may also be utilized such as, by way of non-limiting example, thermocouples and the like. By way of non-limiting example, a separate heater engagement switch 42 may be utilized.

While specific embodiments of the invention have been described and illustrated, such embodiments should be considered illustrative of the invention only and not as limiting the invention as construed in accordance with the accompanying claims.

What is claimed is:

1. An apparatus for heating the handle of an electric hand tool, said handle having an interior wall defining a cavity therein; the apparatus comprising:
an electric heating element adapted to be adhered to said interior wall of said handle; and
an electrical connection adapted to be electrically connected to an electrical supply for said tool.

2. The apparatus of claim 1 wherein each electric heating element is sized to extend around a majority of said interior wall of said handle.

3. The apparatus of claim 1 wherein said electric heating element comprises two electric heating elements.

4. The apparatus of claim 3 wherein each of said two electric heating elements is located inside one half of said handle of said tool.

5. The apparatus of claim 1 wherein said electric heating element comprises a flexible heating element.

6. The apparatus of claim 1 wherein said electrical connection is connected to a switch of said electric hand tool

7. The apparatus of claim 6 wherein said electrical connection includes a temperature controller to interrupt said electrical connection above a predetermined temperature.

8. An electric hand tool comprising:
a tool body having a handle therein, said handle having an interior wall defining a cavity therein;
an electrical supply input cord operable to be connected to a power source;
an electric heating element adapted to be adhered to said interior wall of said handle; and
an electrical connection adapted to be electrically connected to an electrical supply for said tool.

9. The electric hand tool of claim 8 wherein said interior wall of said handle includes a recessed portion sized to receive said electric heating element therein.

10. The electric hand tool of claim 8 wherein each electric heating element is sized to extend around a majority of said interior wall of said handle.

11. The electric hand tool of claim 8 wherein said electric heating element comprises two electric heating elements.

12. The electric hand tool of claim 11 wherein each of said two electric heating elements is located inside one half of said handle of said tool.

13. The electric hand tool of claim 8 wherein said electric heating element comprises a flexible heating element.

14. The electric hand tool of claim 8 wherein said electrical connection is connected to a switch of said electric hand tool

15. The electric hand tool of claim 14 wherein said electrical connection includes a temperature controller to interrupt said electrical connection above a predetermined temperature.
